(19) United States
(12) Patent Application Publication
(10) Pub. No.: US 2021/0095582 A1
(43) Pub. Date: Apr. 1, 2021

(54) ENGINE WITH ROTATING VALVE ASSEMBLY

(71) Applicant: Vaztec Engine Venture, LLC, Mooresville, NC (US)

(72) Inventors: Darrick Vaseleniuck, Mooresville, NC (US); Daniel Cordier, Concord, NC (US); Daniel Sondee, Mooresville, NC (US); Stacey Daniel, Mooresville, NC (US); Thomas Bashford, China Grove, NC (US); Norman H. Garrett, III, Huntersville, NC (US)

(21) Appl. No.: 17/034,971

(22) Filed: Sep. 28, 2020

Related U.S. Application Data
(60) Provisional application No. 62/907,068, filed on Sep. 27, 2019.

(51) Int. Cl. F01L 7/02; F02F 7/00; F02F 3/00; F02F 1/24; F01L 9/04

(52) U.S. Cl. CPC F01L 7/02; F02F 7/0043; F01L 9/04; F02F 1/24; F02F 3/00

(57) ABSTRACT

An engine with rotating assembly is disclosed. The engine includes a block defining a cylinder bore; a crankshaft mounted for rotation in the block; a piston disposed in the cylinder bore; a connecting rod interconnecting the piston to the crankshaft; and a cylinder head coupled to the block having a combustion chamber aligned with the cylinder bore and having an intake opening and an exhaust opening communicating therewith; an intake port; an exhaust port; a rotatable intake valve barrel disposed between the intake opening and the intake port; and a rotatable exhaust valve barrel disposed between the exhaust opening and the exhaust port. A first electric motor is connected to the intake valve barrel and a second electric motor is connected to the exhaust valve barrel, the first electric motor rotates the intake valve barrel and second electric motor rotates the exhaust valve barrel independently of the intake valve barrel.

### BACKGROUND OF THE INVENTION

This invention relates generally to internal combustion engines, and more particularly to engines using rotary valves.

Internal combustion engines are well known and are used in various applications. For example, internal combustion engines are used in automobiles, farm equipment, lawn mowers, and watercraft. Internal combustion engines also come in various sizes and configurations, such as two stroke or four stroke and ignition or compression.

Typically, internal combustion engines include a multitude of moving parts, for example, they include intake and exhaust valves, rocker arms, springs, camshafts, connecting rods, pistons, and a crankshaft. One of the problems with having a multitude of moving parts is that the risk of failure increases (particularly in the valve train) and efficiency decreases due to frictional losses. Special lubricants and coatings may be used to reduce friction and certain alloys may be used to prevent failure; however, even with these enhancements, the risk of failure and the frictional losses remain high. Additionally, when valve trains fail, repairing the broken valve train can be time intensive and require special tools, thereby making it very difficult to repair in the field.

Additionally, controlling the operation of an internal combustion engine through cylinder deactivation, varible valve timing schemes, cylinder decompression, engine braking, and other technologies has become important to allow manufacturers to meet fuel economy standards. Thus, there remains a need for a valve train for an internal combustion engine with low friction, good reliability, a small number of parts, easily repaired, and controllable.

### BRIEF SUMMARY OF THE INVENTION

This need is addressed by the present invention, which provides a valve train made up of individual rotating valve assemblies that are individually controlled.

According to one aspect of the invention, an engine includes a block defining a cylinder bore; a crankshaft mounted for rotation in the block; a piston disposed in the cylinder bore; a connecting rod interconnecting the piston to the crankshaft; and a cylinder head coupled to the block. The cylinder head including a combustion chamber aligned with the cylinder bore and having an intake opening and an exhaust opening communicating therewith; an intake port; an exhaust port; a rotatable intake valve barrel disposed between the intake opening and the intake port; and a rotatable exhaust valve barrel disposed between the exhaust opening and the exhaust port. The engine further including a first electric motor connected to the intake valve barrel and a second electric motor connected to the exhaust valve barrel, wherein the first electric motor rotates the intake valve barrel and second electric motor rotates the exhaust valve barrel independently of the intake valve barrel.

According to another aspect of the invention, an engine includes a block defining a cylinder bore; a crankshaft mounted for rotation in the block; a piston disposed in the cylinder bore; a connecting rod interconnecting the piston to the crankshaft; and a cylinder head coupled to the block. The cylinder head including a combustion chamber aligned with the cylinder bore and having an intake opening and an exhaust opening communicating therewith; an intake port; an exhaust port; a rotatable intake valve barrel disposed between the intake opening and the intake port; and a rotatable exhaust valve barrel disposed between the exhaust opening and the exhaust port. The engine further including a first electric motor connected to the intake valve barrel and a second electric motor connected to the exhaust valve barrel, wherein the first electric motor rotates the intake valve barrel and second electric motor rotates the exhaust valve barrel independently of the intake valve barrel, the first and second electric motors controlling duration of the intake and exhaust valve barrels by controlling a speed of rotation at which the intake and exhaust valves are opened and closed.

### BRIEF DESCRIPTION OF THE DRAWINGS

The invention may be best understood by reference to the following description taken in conjunction with the accompanying drawing figures in which:

FIG. 1 is a cross-section of a V-configuration internal combustion engine with individually controlled rotating valve assemblies;

FIG. 2 is a cross-section of a single cylinder internal combustion engine with an individually controlled rotating valve assembly; and

FIG. 3 is an exploded view of individually controlled rotating valves used in the internal combustion engines shown in FIGS. 1 and 2.

### DETAILED DESCRIPTION OF THE INVENTION

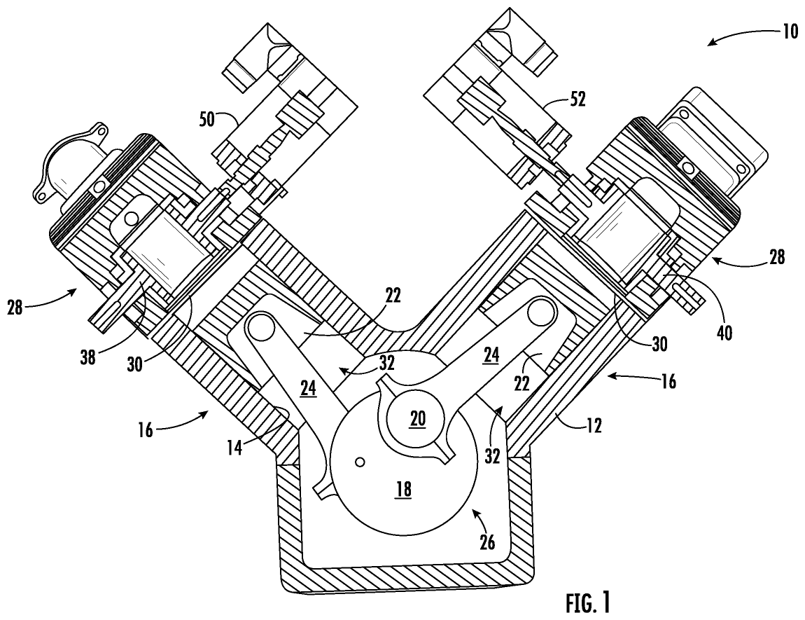

Referring to the drawings wherein identical reference numerals denote the same elements throughout the various views, FIG. 1 illustrates an exemplary internal combustion engine 10 constructed according to an aspect of the present invention.

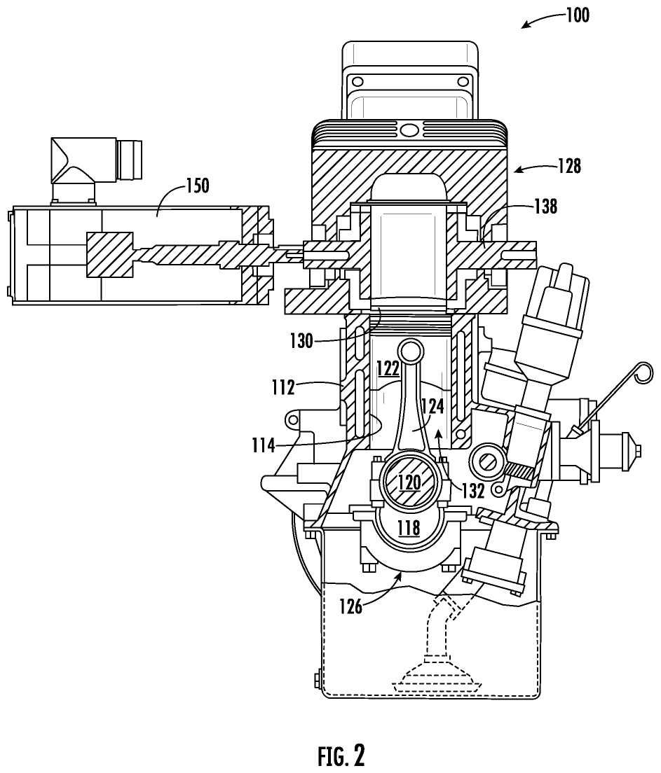

The illustrated example is an eight-cylinder engine 10 of vee configuration, commonly referred to as a “V-8”, with two banks of four cylinders set 90 degrees to each other. However, it will be understood that the principles of the present invention are applicable to any internal combustion engine, for example the single cylinder internal combustion engine depicted in FIG. 2 at reference numeral 100, engines running various cycles such as Otto, Atkinson, Miller, or Diesel cycles, or similar machines requiring valves to open and close fluid flow ports.

The engine includes a block 12 which serves as a structural support and mounting point for the other components of the engine 10. Generally cylindrical cylinder bores 14 are formed within the block 12. As noted above the cylinder bores 14 are arranged in two longitudinal cylinder banks 16 of four cylinder bores 14 each. A crankshaft 18 having offset crankpins 20 is mounted in the block 12 for rotation in suitable bearings. A piston 22 is disposed in each cylinder bore 14, and each piston 22 is connected to one of the crankpins 20 by a piston rod 24. The crankshaft 18, piston rods 24, and pistons 22 collectively define a rotating assembly 26. In operation, gas pressure in the cylinder bores 14 causes linear movement of the pistons 22, and the rotating assembly 26 is operable in a known manner to convert linear movement of the pistons to rotation of the crankshaft.

The engine includes one cylinder head assembly 28 attached to each cylinder bank 16. The cylinder head assembly 28 has a generally concave combustion chamber 30 formed therein corresponding to and aligned with each cylinder bore 14. Collectively, each cylinder bore 14 and the corresponding combustion chamber 30 defines a cylinder 32. Other embodiments may provide multiple cylinder heads for a single group or bank of cylinders such as is known to those skilled in the art of engine design.

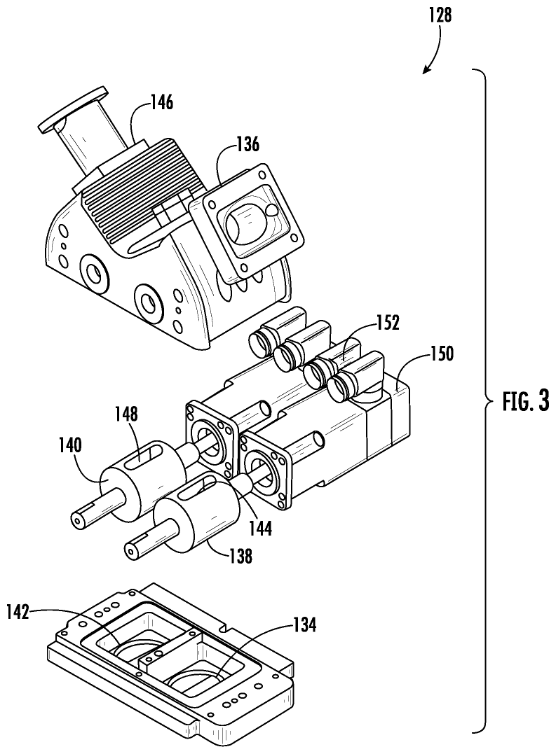

The cylinder head assembly 28 has a plurality of intake and exhaust ports formed therein; each intake port extends from one of the combustion chambers 30 to an intake plane at an exterior surface of the cylinder head assembly 28. Likewise, each exhaust port extends from one of the combustion chambers 30 to an exhaust plane at an exterior surface of the cylinder head assembly 28. The intake and exhaust ports will be described in more detail with reference to FIGS. 2 and 3. In some embodiments, multiple intake ports or exhaust ports may be provided, their respective fluid flow being controlled by the rotary valves described herein.

Like internal combustion engine 10, internal combustion engine 100 includes a block 112; a cylinder bore 114; a crankshaft 118; a crankpin 120; a piston 122; a piston rod 124; rotating assembly 126 defined by the crankshaft 118, piston rod 124, and piston 122; a cylinder head assembly 128; a combustion chamber 130; and a cylinder 132. Unlike engine 10, engine 100 is a single cylinder engine.

Referring to FIG. 3, head assembly 128 houses an intake valve barrel 138 and an exhaust valve barrel 140 that are disposed across an intake port 134 and exhaust port 142, respectively. The intake port 134, intake valve barrel 138, and intake aperture 144 are arranged such that in a first angular orientation of the intake valve barrel 138, fluid flow is permitted between the intake plane 136 and the combustion chamber 130, and at a second angular orientation of the intake valve barrel 138, fluid flow is blocked between the intake plane 136 and the combustion chamber 130. Likewise, exhaust port 142, exhaust valve barrel 140, and exhaust aperture 148 are arranged such that in a first angular orientation of the exhaust valve barrel 140, fluid flow is permitted between the exhaust plane 146 and the combustion chamber 30, and at a second angular orientation of the exhaust valve barrel 140, fluid flow is blocked between the exhaust plane 146 and the combustion chamber 30.

Electric motors 150 and 152 are connected to the intake and exhaust valve barrels 138, 140 respectively. The electric motors 150 and 152 are used to control rotation of the valve barrels 138 and 140. In FIG. 1, the electric motors are labeled as reference numerals 50 and 52. The electric motors 150 and 152 may be servo motors, step motors, or any other suitable electric motor for rotating the intake and exhaust barrels 138, 140 in a controlled manner. Other methods of controlling the rotation of the valve barrels may also be employed. In some embodiments of the invention, only a chosen rotary valve barrel may be controlled by an electric motor and the other rotary valve or valves may be driven by more traditional means such as using gears, belts, or chains, thus lowering the cost of the engine assembly. In other embodiments, a single barrel valve containing both an intake and an exhaust port may be provided, said valve being driven by an electric motor rotating at a constant or chosen variable rate to affect the desired performance in an engine's operating characteristics.

Such a configuration allows for autonomous operation of individual rotary valve(s) via servo motor independent of crankshaft position. Valve motion is no longer fixed to direction of crankshaft rotation, rate of speed or position. The use of a belt, chain or gearset is no longer required to maintain the timing event of valve opening, closing or motion related to the pistons position in the cylinder to enable the combustion events/process. This new methodology creates the opportunity for each cylinder to function independently.

The electric motors 150, 152 may be connected to the valve barrels via, but not limited to:
Direct drive from servo shaft into machined receiver or attachment in/on rotary valve; and
Attached via Gear, Belt, Chain or driveshaft from servo motor to rotary valve.

The electric motor drive valve barrels enables:
Engine Braking (“jake brake”);
Control of valve timing to reduce noise emissions DBA (holding valve closed till lower cylinder pressure);
Variable Valve Timing (in relation to piston position);
Altered Dynamic Compression Ratio (IE; fuel octane reduction/availability)
Changing Engine Rotation Direction (clockwise to counterclockwise);
Independent Cylinder Deactivation (fuel economy strategy);
Altered Duration or Timing event (related to time valve is open or closed);
Changing valve motion from linear motion into nonlinear motion (speed up/slow down);
Alter full rotation vs shuttling movements based upon demand/RPM (index vs rotation);
Lower cranking demands placed on starter motor/electrical system (smaller battery);
Rotation of valve in opposite direction of crankshaft (boats, operation of reversing);
Control of “overlap event” for given “condition” (condition ex: idle vs maximum output); and
Altered (individual) Event Strategy cylinder to cylinder in multiple cylinder based engines.

Further, the configuration provides the benefits of:
No mechanical risk of piston to valve clearance issue for altered timing events;
Lower friction of Rotary system to enable servo use;
Rotary flow though design allows direction change, shuttle motion or full rotation;
Consistent rotational torque throughout motion (unlike spring-based system);
Broader use of same engine across multiple platforms;
Cost reduction of parts in que with removal of drive system/reduction of failure modes;
Removal of drive, reduces parasitic loss to lower fuel consumption (MPG/Emissions); and
Ease of assembly procedure.

In operation, decoupling the rotary engine valves from the crankshaft allows for a multitude of valve timing strategies that are unattainable with current mechanical driven valves. For example:
Driving the rotary valves independently with electronic servo valves allows for cylinder deactivation. For example: On V8 engines under low load conditions, 4 of the 8 cylinders could be deactivated by rotating the valves to the open position to allow the cylinder pressure to escape to atmosphere removing any load or strain from the crankshaft.
Driving the rotary valves with electric servos also allows for engine braking. Unlike cylinder deactivation which leave the valve open, exhaust braking would allow the exhaust valves to remain closed during the exhaust stroke to create pressure and resistance to the crankshaft slowing the engine speed.
Driving the servo driven rotary valves independently also allows for diameter changes unrelated to the crankshaft to valve ratio. For example: Opening the valve rapidly to wide open and decreasing speed to close changes the length of time the valve is open relative to the crankshaft speed, also called the duration. The opposite could be done where you open the valve slow and close the valve fast in order to shorten the duration. This allows the intake and exhaust barrel diameters to be of differing diameters or of the same diameter.

The engines 10 and 100 include a fuel delivery system (not shown) which is operable to receive an incoming airflow, meter a hydrocarbon fuel such as gasoline into the airflow to generate a combustible intake mixture, and deliver the intake mixture to the cylinders 32 and 132.

The fuel delivery system may be continuous flow or intermittent flow, and the fuel injection point may be at the individual cylinders 32 or at an upstream location. Optionally the fuel injection point may be within the cylinders 32, a configuration commonly referred to as “direct injection”, in which case the intake ports 34 deliver only air to the cylinders 32. Known types of fuel delivery systems include carburetors, mechanical fuel injection systems, and electronic fuel injection systems. The specific example illustrated is an electronic fuel injection system with one intake runner connected to each intake port 34.

The engines 10 and 100 include an ignition system (not shown) comprising one or more spark plugs mounted in each combustion chamber 30, to ignite the intake mixture. An appropriate ignition power source is provided, such as a conventional Kettering ignition system with a coil and distributor, or a direct ignition system with a trigger module and multiple coils. The ignition power source is connected to the spark plugs, for example with leads.

It will be understood that the present invention may be implemented as a complete engine, or that the cylinder head assemblies described herein may be retrofitted to an existing internal combustion engine, or that the rotating valve assembly may be incorporated into a cylinder head design.

The foregoing has described an engine with rotating valve assembly. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An engine, comprising:
a block defining a cylinder bore;
a crankshaft mounted for rotation in the block;
a piston disposed in the cylinder bore;
a connecting rod interconnecting the piston to the crankshaft; and
a cylinder head coupled to the block and including:
a combustion chamber aligned with the cylinder bore and having an intake opening and an exhaust opening communicating therewith;
an intake port;
an exhaust port;
a rotatable intake valve barrel disposed between the intake opening and the intake port; and
a rotatable exhaust valve barrel disposed between the exhaust opening and the exhaust port;
a first electric motor connected to the intake valve barrel and a second electric motor connected to the exhaust valve barrel, wherein the first electric motor rotates the intake valve barrel and second electric motor rotates the exhaust valve barrel independently of the intake valve barrel.

2. The engine of claim 1, wherein the intake valve barrel has a first diameter and the exhaust valve barrel has a second diameter different from the first diameter.

3. The engine of claim 1, wherein the first and second electric motors control valve rotation of the intake and exhaust valve barrels.

4. The engine of claim 3, wherein the first and second electric motors control valve rotation speed.

5. The engine of claim 3, wherein the first and second electric motors control valve rotation direction.

6. The engine of claim 3, wherein the first and second electric motors control start and stop positions of the intake and exhaust valve barrels.

7. The engine of claim 1, wherein the intake valve barrel has a first diameter and the exhaust valve barrel has a second diameter equal to the first diameter.

8. An engine, comprising:
a block defining a cylinder bore;
a crankshaft mounted for rotation in the block;
a piston disposed in the cylinder bore;
a connecting rod interconnecting the piston to the crankshaft; and
a cylinder head coupled to the block and including:
a combustion chamber aligned with the cylinder bore and having an intake opening and an exhaust opening communicating therewith;
an intake port;
an exhaust port;
a rotatable intake valve barrel disposed between the intake opening and the intake port; and
a rotatable exhaust valve barrel disposed between the exhaust opening and the exhaust port;
a first electric motor connected to the intake valve barrel and a second electric motor connected to the exhaust valve barrel, wherein the first electric motor rotates the intake valve barrel and second electric motor rotates the exhaust valve barrel independently of the intake valve barrel, the first and second electric motors controlling duration of the intake and exhaust valve barrels by controlling a speed of rotation at which the intake and exhaust valves are opened and closed.

9. The engine of claim 8, wherein the intake and exhaust valves are rotated to an open position at a first rotation speed and rotated to a closed position at a second rotation speed slower than the first rotation speed to increase duration.

10. The engine of claim 8, wherein the intake and exhaust valves are rotated to an open position at a first rotation speed and rotated to a closed position at a second rotation speed faster than the first rotation speed to decrease duration.

11. An engine, comprising:
a block defining a cylinder bore;
a crankshaft mounted for rotation in the block;
a piston disposed in the cylinder bore;
a connecting rod interconnecting the piston to the crankshaft; and
a cylinder head coupled to the block and including:
a combustion chamber aligned with the cylinder bore and having an intake opening and an exhaust opening communicating therewith;
an intake port;
an exhaust port;
a rotatable barrel comprising both an intake valve disposed between the intake opening and the intake port and a rotatable exhaust valve barrel disposed between the exhaust opening and the exhaust port;
an electric motor connected to the valve barrel, wherein the electric motor controls the duration of the intake and exhaust valve barrel by controlling a speed of rotation at which the intake and exhaust valves and thus the respective ports are opened and closed.
